(19) United States
(12) Patent Application Publication
(10) Pub. No.: US 2007/0092855 A1
(43) Pub. Date: Apr. 26, 2007

(54) Molding made from a dental alloy for producing dental parts

(75) Inventors: Friedrich SERNETZ, Pforzheim (DE); Jurgen LINDIGKEIT, Konigsbach-Stein (DE)

Correspondence Address: LEYDIG VOIT & MAYER, LTD, 700 THIRTEENTH ST. NW, SUITE 300, WASHINGTON, DC, 20005-3960, US

(73) Assignee: DENTAURUM J.P. WINKELSTROETER KG, Ispringen (DE)

(21) Appl. No.: 11/532,182

(22) Filed: Sep. 15, 2006

(30) Foreign Application Priority Data
Sep. 20, 2005 (DE) 10 2005 045 698.7

(51) Int. Cl. A61C 5/08; C22C 1/04; B22F 3/15; C22C 32/00; C04B 35/64; C04B 33/32; C04B 33/36

(52) U.S. Cl. 433/218; 419/23; 419/49; 264/603

(57) ABSTRACT

A molding can be worked by removing material to produce dental parts of improved mechanical properties is provided, the molding consisting of a dental alloy powder dense-sintered by hot-isostatic pressing.

The invention relates to a molding which consists of a dental alloy and can be worked by removing material to produce dental parts, such as for example crowns and bridges or corresponding structures.

Dental alloys are usually processed in a dental laboratory by means of the lost wax method to form dental parts, in particular dental restorations, such as for example crowns, bridges or corresponding structures. This casting process allows for example a crown or bridge to be correspondingly modeled by a dental technician on the basis of an impression previously taken in the mouth of the patient, and the crown or structure of the tooth concerned to be restored. A large number of dental alloys containing precious metals or free from precious metals may be used for this process. The dental part produced according to this process has a metallurgical structure and mechanical properties corresponding to the cast state of a so-called precision casting. The production involves a high degree of manual craftsmanship and is consequently cost-intensive.

Furthermore, corresponding cast structures are coarse-grained and often have typical casting defects such as voids, porosities, segregations and inhomogeneities, which lead to poorer mechanical properties in comparison with fine-grained structures and may have increased susceptibility to corrosion, and consequently reduced tolerance by the patient's body.

In recent years, the use of so-called CAD/CAM techniques (computer-aided design, CAD, and computer-aided manufacturing, CAM) for the production of dental parts such as for example crowns and bridges has also increased in custom-made production, in dental laboratories, of work for patients. Known for this is the so-called CEREC process, published in “Quintessenz”, March 1987, pages 457 to 470, in which a molding consisting of dental ceramic is ground on a multiaxis machining center after the input of corresponding scanning data for the circumstances of the tooth to form a dental restoration. The data required for controlling the machining center are obtained by scanning a model of the tooth or by scanning the tooth in the mouth and verification by the dentist or dental technician.

Metallic dental parts such as crowns and bridges are also increasingly being produced by means of such CAD/CAM techniques, by working a molding made from a dental alloy by removing material, in particular by milling. The moldings are generally cylindrical or square-shaped and are usually produced by the casting process or by forming processes such as forging, pressing and/or rolling. Moldings produced from a dental alloy by the casting process are usually coarse-grained and, even if a precision casting process and so-called grain refiners, as described for example in DE 38 21 204 C2, are used, cannot be produced with such fine grains as those dental parts that are cast directly in the dental process, which tend to be relatively small parts. In particular in the case of precious metal-free CoCr and NiCr dental alloys, the coarse-dendritic cast structure that is typical of these alloys leads to poorer mechanical properties of a dental part machined from such a molding than is the case with a direct dental casting. Although forming such as pressing, forging and/or rolling allows the primary coarse cast structure to be converted into a fine-grained microstructure with improved mechanical properties, the production process becomes significantly more expensive as a result. Added to this is the fact that it is not possible for all dental alloys that are commonly used in a dental laboratory to be worked by forming, since the formability characteristics depend greatly on the chemical composition of the dental alloy and even a small proportion of alloying elements and slight impurities can have a great influence. For example, in the case of orthopedic implant forging alloys, considerable proportions of nickel are added to increase the formability of CoCr alloys, although the allergic effect of this element is known.

The production of metallic moldings from dental alloys for CAD/CAM techniques by means of a powder-metallurgical process instead of a casting or forming process is described in DE 103 42 231 A1. the case of the molding described there, importance is attached to the fact that the molding is open-pored and not dense-sintered, to allow it to be worked more easily. Only after completion of the final form are the open pores of the molding closed with a second alloy in a further working step, by means of an infiltration process. However, the use of a metallic composite material in a dental application is very disadvantageous because of the susceptibility to corrosion of the material composite comprising two alloys.

It is an object of the present invention to provide a molding of the type mentioned at the beginning with improved mechanical properties in comparison with the casting process of production in particular.

This object is achieved according to the invention in the case of a molding of the type mentioned at the beginning by the molding consisting of a dental alloy powder dense-sintered by hot-isostatic pressing.

To produce the molding according to the invention, firstly a dental alloy powder is produced from the melt of a dental alloy, in particular under an inert gas atmosphere, for example argon, by means of known atomizing techniques. The powder is subjected to a hot-isostatic pressing process, with the aid of which it can be compacted to the extent that the theoretical density of the dental alloy can ultimately be achieved. The molding produced in this way can subsequently be worked by removing material, in particular removing chips, to produce the dental part, for example a dental restoration, in particular a crown, bridge or a corresponding structure.

Moldings of a dental alloy powder which has been dense-sintered by hot-isostatic pressing have a fine powder-metallurgical structure with mechanical properties that are surprisingly significantly improved in comparison with the cast structure. This applies in particular to the tensile strength and the expansion behavior. Given the same chemical composition, the structure is distinguished by a fine-globular structure as compared with a coarse-dendritic structure in the cast state, even in the case of large dimensions and a great mass of the molding. The advantage of the fine-globular structure is not only that of improved mechanical properties but also that of an improvement in the specific technological properties that are desirable in the production of dental parts, in particular dental restorations: the effort required for milling out the dental part is reduced by virtue of the better machinability, and a possibly required fine dimensional correction of the dental part by finishing being performed by the dental technician and/or dentist is improved by the greater ductility of the molding according to the invention.

Apart from an improvement in the mechanical and technological properties, the use of the hot-isostatic pressing process in the case of a dental alloy powder also leads to guaranteed freedom from pores and voids, which in the case of casting processes and relatively large moldings and in the case of other powder-metallurgical processes requires very great effort and nevertheless cannot be completely achieved.

Another advantage to be pointed out is that the dental alloys that are known per se for the casting process, of known biological tolerance and capable of being economically produced even in relatively small amounts, can be used in a dental laboratory.

During the hot-isostatic pressing, the dental alloy powder is preferably introduced into a capsule which is gastight and sealed in a gastight manner. The gastight capsule, in particular with thin waits, is preferably produced from high-grade seal and is welded with a gastight seal once the dental alloy powder has been filled into it.

The dental alloy powder may, for example, have an apparent density of less than 5 g/cm³, for example an apparent density of 4.8 g/cm³. The gastight capsule is oversized, allowing for the corresponding shrinkage in volume or material compaction during the hot-isostatic pressing. The capsule is preferably of a tubular configuration, allowing production of a dense-sintered round-block molding which, after removal from the capsule, can be worked to its final dimensions, for example by sawing and turning of the outside diameter.

When it is introduced into the capsule, the dental alloy powder preferably has a grain size distribution of <400 micrometers, in particular <100 micrometers. It has been found that, with such a grain size distribution, particularly good mechanical properties of the dense-sintered molding can be achieved.

It is advantageous if, when it is introduced into the capsule, the dental alloy powder has an average grain size of 30 to 50 micrometers, in particular 40 micrometers. It may be provided that the dental alloy powder is filled directly into the gastight capsule, it being possible for example for the filling to be assisted by shaking. Alternatively, it may be provided that, before it is introduced into the capsule, the dental alloy powder is pre-pressed into a powder compact, so that a preferably cold-isostatically pre-pressed powder compact is placed in the capsule. It is also possible for a porous body produced from the dental alloy powder in some other powder-metallurgical manner to be introduced into the gastight capsule and subsequently compacted hot-isostatically.

In the case of an advantageous embodiment, the pre-pressed powder compact is pre-compacted by sintering before it is introduced into the gastight capsule.

It may alternatively be provided that the dental alloy powder is first pre-pressed and pre-compacted by sintering to give closed porosity and subsequently post-compacted without a capsule by hot-isostatic pressing. Therefore, depending on the remaining porosity, the pre-pressed powder compact may be subjected to the hot-isostatic pressing process either without a capsule or with encapsulation.

The invention is explained in more detail below on the basis of an exemplary embodiment. In order to obtain a molding from a CoCr dental alloy with the chemical composition Co 60.5%, Cr 28%, W 9%, Si 1.5%, Mn<1%, N<1%, Nb<1% (percentages by mass) in the form of a cylinder with a diameter of 100 mm and a height of 16 mm, firstly a melt of said CoCr dental alloy is produced in the usual way. The alloy is melted in a commercial powder atomizing installation under argon inert gas and subsequently atomized into a dental alloy powder with a grain size distribution of <100 micrometers and an average grain size of 40 micrometers. The apparent density of this dental alloy powder is 4.8 g/cm³³, and consequently 56% of the theoretical density.

For the hot-isostatic pressing, a gastight high-grade steel capsule is produced with an oversize, which allows for the corresponding volume shrinkage or material compaction during the hot-isostatic pressing. The capsule is produced for example in a tubular form with a diameter of 130 mm and a height of 1200 mm, the bottom, top and side-wall having a wall thickness of 2 mm. Welded into the top is a suction removal connector, through which the dental alloy powder is filled and is shaken during filling, in order to achieve a compact fill. After filling with the powder, the capsule is evacuated and then the suction removal connector is welded in a gastight manner. The capsule is subsequently placed in the pressure chamber of a hot-isostatic press and heated up at a rate of 20° C./min to a temperature of 600° C. At the same time, a preliminary pressure of 300 bar is built up with argon gas in the pressure chamber, and this is increased to 650 bar during the heating up. The temperature of 600° C. is maintained for one hour at a constant pressure, and subsequently the temperature is raised further to 1150° C. by heating up at a rate of 3° C./min, the gas pressure being increased to 1000 bar when 750° C. is reached and kept constant until a holding time of three hours at 1150° C. has elapsed. The simultaneous application of a high gas pressure on all sides and a high temperature has the effect that the dental alloy powder in the gastight capsule sinters together to the theoretical density and the capsule shrinks correspondingly. After elapse of the holding time of 3 hours at 1150° C., the heating of the hot-isostatic press is switched off and the pressure in the pressure chamber is reduced. Once the hot-isostatic pressing cycle is ended, the capsule can be removed from the pressure chamber, at which point it has shrunk to a diameter of 107 mm and a length of about 1100 mm. The moldings are then finished to the final dimensions from the compacted round block by sawing and turning of the outside diameter.

A molding formed in this way is distinguished by the mechanical properties listed below, which are significantly improved in comparison with a conventional cast structure:

| | |
|---|---|
| HIP process | Casting process |

| Yield point R_{p 0.2}: | 630 | MPa | 620 | MPa |
|---|---|---|---|---|
| Tensile strength Rₘ: | 1100 | MPa | 845 | MPa |
| Hardness HV 10: | 325 | | 280 | |
| Elongation at break A₅: | 32% | | 10.2% | |
| Density: | 8.6 | g/cm³ | 8.6 | g/cm³ |

Listed above in the first column are the mechanical properties achieved in the case of the molding explained above, produced from a dental alloy powder dense-sintered by hot-isostatic pressing (HIP). Listed in the second column for comparison are the corresponding mechanical properties of a comparable cast structure. Given the same chemical composition, the molding according to the invention is distinguished by significantly improved mechanical properties, even in the case of large dimensions and a great mass.

1. A molding can be worked by removing material to produce dental parts, the molding consisting of a dental alloy powder dense-sintered by hot-isostatic pressing.

2. The molding according to claim 1, wherein, during the hot-isostatic pressing, the dental alloy powder is filled into a capsule which is gastight or sealed in a gastight manner.

3. The molding according to claim 2, wherein, before it is filled into the capsule, the dental alloy powder has a grain size distribution of <400 micrometers.

4. The molding according to claim 2, wherein, before it is filled into the capsule, the dental alloy powder has an average grain size of 30 to 50 micrometers.

5. The molding according to claim 2, wherein, before it is filled into the capsule, the dental alloy powder has been pre-pressed into a powder compact.

6. The molding according to claim 5, wherein, before it is filled into the capsule, the pre-pressed powder compact has been pre-compacted by sintering.

7. The molding according to claim 1, wherein the dental alloy powder has first been pre-pressed and pre-compacted by sintering to give closed porosity and subsequently post-compacted without a capsule by hot-isostatic pressing.

8. The molding according to claim 3, wherein, before it is filled into the capsule, the dental alloy powder has an average grain size of 30 to 50 micrometers.

9. The molding according to claim 3, wherein, before it is filled into the capsule, the dental alloy powder has been pre-pressed into a powder compact.

10. The molding according to claim 4, wherein, before it is filled into the capsule, the dental alloy powder has been pre-pressed into a powder compact.

11. The molding according to claim 1, wherein the dental alloy dense-sintered by hot-isostatic pressing has a fine-globular structure.

12. The molding according to claim 2, wherein the dental alloy dense-sintered by hot-isostatic pressing has a fine-globular structure.

13. A method for producing a molding which can be worked by removing material to produce dental parts comprising dense-sintering a dental alloy powder by hot-isostatic pressing.

14. The method of claim 13, wherein, during the hot-isostatic pressing, the dental alloy powder is filled into a capsule which is gastight or sealed in a gastight manner.

15. The method of claim 14, wherein, before it is filled into the capsule, the dental alloy powder has a grain size distribution of <400 micrometers.

16. The method of claim 14, wherein, before it is filled into the capsule, the dental alloy powder has an average grain size of 30 to 50 micrometers.

17. The method of claim 14, wherein, before it is filled into the capsule, the dental alloy powder has been pre-pressed into a powder compact.

18. The method of claim 17, wherein, before it is filled into the capsule, the pre-pressed powder compact has been pre-compacted by sintering.

19. The method of claim 13, wherein the dental alloy powder has first been pre-pressed and pre-compacted by sintering to give closed porosity and subsequently post-compacted without a capsule by hot-isostatic pressing.

20. The method of claim 15, wherein, before it is filled into the capsule, the dental alloy powder has been pre-pressed into a powder compact.
